(19) United States
(12) Patent Application Publication
(10) Pub. No.: US 2007/0213930 A1
(43) Pub. Date: Sep. 13, 2007

(54) Position Estimation System

(76) Inventors: Kiyomi Sakamoto, Nara (JP); Atsushi Iisaka, Osaka (JP); Atsushi Yamashita, Osaka (JP); Noboru Nomura, Kyoto (JP); Hiroyuki Ogino, Nara (JP); Shigeki Ueda, Nara (JP)

Correspondence Address: WENDEROTH, LIND & PONACK L.L.P., 2033 K. STREET, NW, SUITE 800, WASHINGTON, DC, 20006, US

(21) Appl. No.: 11/578,328

(22) PCT Filed: May 21, 2004
(86) PCT No.: PCT/JP04/07301

§ 371 Date: Oct. 13, 2006

(51) Int. Cl. G01C 21/00

(52) U.S. Cl. 701/213; 701/200

(57) ABSTRACT

In a position estimation apparatus, an information acquisition/storage section 3 acquires, when a receiver 1 can track an artificial satellite, a current position obtained from the receiver 1 and an output value from each of pressure sensors 2R and 2L, and then stores at least a travel speed and a travel direction for a user and the obtained output value. Also, when the receiver 1 cannot track the artificial satellite, a locator 4 in the position estimation apparatus retrieves, from the information acquisition/storage section 3, a travel speed and a travel direction of the user based on the output value acquired from each of the sensors 2R and 2L and the output value stored in the information acquisition/storage section 3. Thereafter, the locator 4 estimates a current position of the user based on the retrieved travel speed and travel direction.

### TECHNICAL FIELD

The present invention relates to a position estimation apparatus, and more particularly, a position estimation apparatus for estimating a current position in order to navigate a pedestrian.

### BACKGROUND ART

Recently, navigation apparatuses for a pedestrian has been on the market. In many cases, such a navigation apparatus uses a receiver of GPS (Global Positioning System) and, based on information obtained from a plurality of artificial satellites, periodically identifies a current position of a pedestrian (so-called “radio navigation”). In order to navigate the pedestrian, the navigation apparatus typically superimposes a mark indicating the identified current position on a map image showing a vicinity of the current position, and displays a thus obtained image on a display thereof.

### DISCLOSURE OF THE INVENTION

However, a user may move in a place such as underground or indoors where radio waves from an artificial satellite do not reach. In such a case, a conventional navigation apparatus has a problem that a current position of a pedestrian cannot be identified by using radio navigation.

Therefore, an object of the present invention is to provide a position estimation apparatus operable to autonomously estimate a current position of a user without depending on radio waves from an artificial satellite.

To achieve the above object, a first aspect of the present invention is directed to a position estimation apparatus comprising: a receiver for receiving information sent from an artificial satellite and deriving a current position based on the received information; a right-side pressure sensor for detecting a pressure applied from a right foot of a user to a ground; a left-side pressure sensor for detecting a pressure applied from a left foot of the user to the ground; and an information acquisition/storage section for acquiring a piece of predetermined information when the receiver is able to track the artificial satellite. Here, the information acquisition/storage section acquires the current position obtained from the receiver and an output value from each of the pressure sensors, derives a travel speed and a travel direction of the user based on the current position obtained from the receiver, and then stores at least the derived travel speed and travel direction and the obtained output value. The position estimation apparatus further comprises a locator for acquiring an output value from each of the sensors when the receiver is unable to track the artificial satellite. Here, the locator retrieves the travel speed and the travel direction of the user from the information acquisition/storage section based on the output value acquired from each of the sensors and the output value stored in the information acquisition/storage section, and further estimates a current position of the user based on the retrieved travel speed and travel direction.

Preferably, the locator selects, from among output values stored in the information acquisition/storage section, an output value correlating with that acquired from each of the sensors, and then retrieves, together with the selected output value, the travel speed and travel direction stored in the information acquisition/storage section.

Preferably, the locator selects, from among temporal waveforms for output values stored in the information acquisition/storage section, a temporal waveform correlating with that for the output value acquired from each of the sensors.

Typically, the locator respectively integrates the retrieved travel speed and travel direction so as to estimate the current position of the user.

Preferably, the sensors are respectively provided to outsoles of a pair of shoes. Also, each of the sensors typically includes a piezo element.

Further, a second aspect of the present invention is directed to a position estimation method comprising: a position measurement step of receiving information sent from an artificial satellite and deriving a current position based on the received information; a detection step of detecting a pressure applied from a foot of a user to a ground; a first acquisition step of acquiring the current position obtained in the position measurement step and a value of the pressure detected in the detection step when tracking the artificial satellite is possible; a storage step of deriving a travel speed and a travel direction of the user based on the current position obtained in the position measurement step, and then storing at least the derived travel speed and travel direction and the value of the pressure obtained in the first acquisition step; a second acquisition step of acquiring the value of the pressure obtained in the detection step when tracking the artificial satellite is impossible; a third acquisition step of retrieving the travel speed and travel direction, of the user, stored in the storage step, based on the value of the pressure acquired in the second acquisition step and the value of the pressure stored in the storage step; and a position estimation step of estimating the current position of the user based on the travel speed and the travel direction obtained in the third acquisition step.

According to the first and the second aspects, when an artificial satellite can be tracked, a current position is obtained using radio navigation, and also, a value of a pressure applied from each foot of the user to the ground is obtained. With reference to such information, a current position of the user is estimated based on the value of the pressure obtained when an artificial satellite cannot be tracked. Accordingly, it is possible to provide a position estimation apparatus operable to autonomously estimate a current position of the user without depending on radio waves from an artificial satellite.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing an entire configuration of a position estimation apparatus according to an embodiment of the present invention.

FIG. 2 is a schematic diagram exemplarily showing a method for arranging a pressure sensor 2R.

FIG. 3 shows temporal waveforms for voltage values outputted from pressure sensors 2R and 2L shown in FIG. 1 when a user walks straight.

FIG. 4 shows temporal waveforms for voltage values outputted from the pressure sensors 2R and 2L shown in FIG. 1 when a user runs straight.

FIG. 5 shows temporal waveforms for voltage values outputted from the pressure sensors 2R and 2L shown in FIG. 1 when a user turns right.

FIG. 6 shows temporal waveforms for voltage values outputted from the pressure sensors 2R and 2L when a pedestrian temporarily stops during walking.

FIG. 7 is a schematic diagram showing information to be stored in an information acquisition/storage section 3 shown in FIG. 1.

FIG. 8 is a flowchart exemplarily showing an operation of the position estimation apparatus shown in FIG. 1.

FIG. 9 is a schematic diagram exemplarily showing a position estimated by the present position estimation apparatus.

### BEST MODE FOR CARRYING OUT THE INVENTION

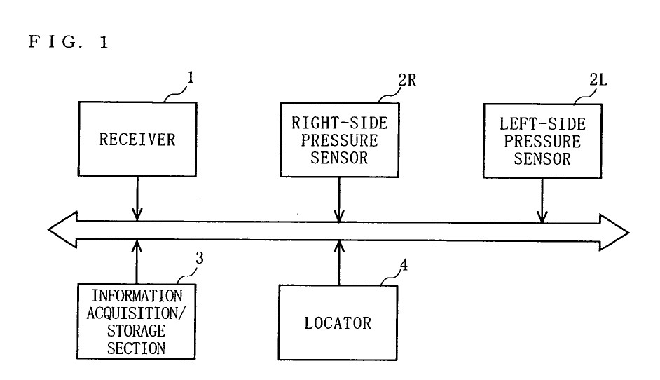

FIG. 1 is a block diagram showing an entire configuration of a position estimation apparatus according to an embodiment of the present invention. In FIG. 1, the position estimation apparatus is incorporated in an electronic equipment operable to perform a route guidance for a user, and estimates a current position of the user. In order to realize the function, the position estimation apparatus includes: a receiver 1; a right-side pressure sensor 2R (hereinafter, simply referred to as a “sensor 3R”); a left-side pressure sensor 2L (hereinafter, simply referred to as a “sensor 3L”); an information acquisition/storage section 3; and a locator 4.

The receiver 1 derives a current position of the user by using radio navigation. Such a receiver 1 tracks a plurality of GPS satellites and derives the current position of the user by using information sent from each of the tracked GPS satellites, for example. Further, a GPS receiver such as the above can obtain a current time from the information sent from each of the GPS satellites.

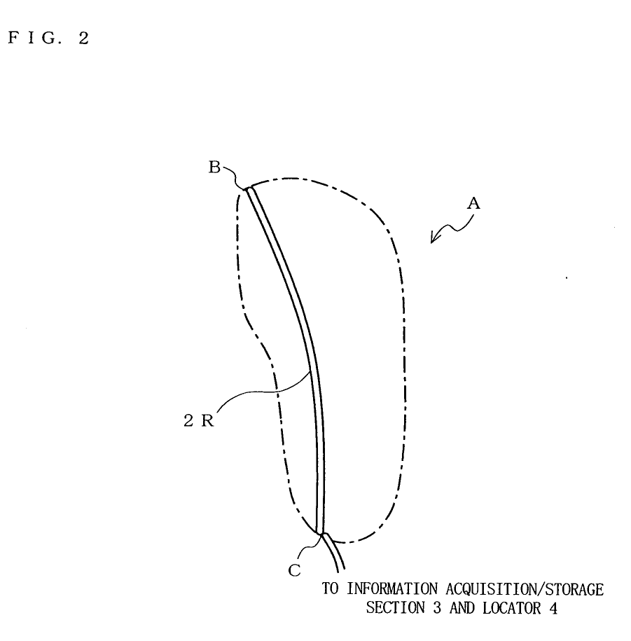

Each of the sensors 2R and 2L typically includes a piezo element and outputs a voltage value correlating with a pressure applied thereto. The sensor 2R has a shape of a narrow bar having a predetermined length as exemplarily shown in FIG. 2. Such a sensor 2R is arranged on an insole A of a right shoe schematically shown with alternate long and short dashed lines in FIG. 2. Preferably, the sensor 2R is arranged so as to connect between a contact point B for a heel and a contact point C for a big toe on the insole A. As the above description clearly indicates, the sensor 2R is so arranged to a position that it is possible to detect a pressure applied when a right foot of the user steps on something. The sensor 2L is arranged on an insole of the left shoe in a similar manner to the sensor 2R. Also, it is preferable that a plurality of sensors 2R and 2L be respectively arranged on insoles of the both side of shoes in a grid manner, in order to accurately measure characteristics of movements of the user. Alternatively, each of the plurality of sensors 2R and 2L may be arranged concentrically or radially.

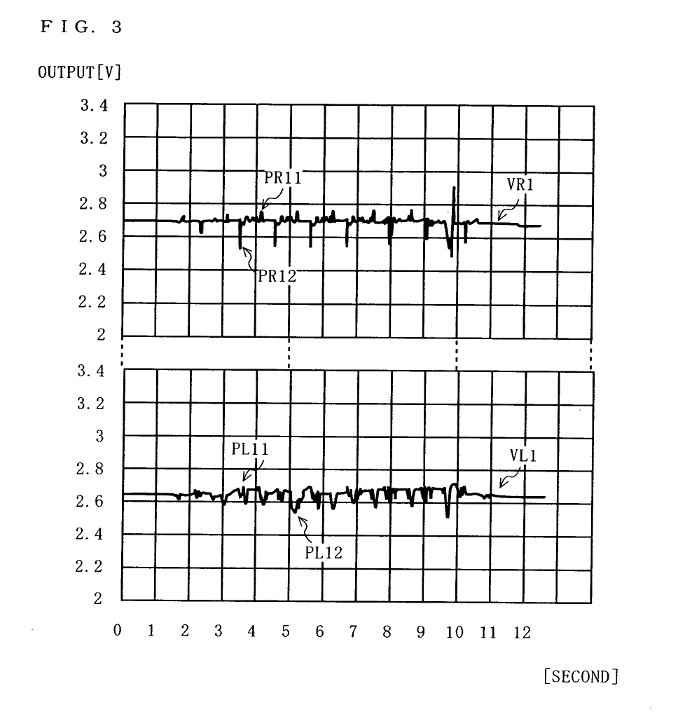

FIG. 3 is a diagram exemplarily showing temporal waveforms VR1 and VL1 for voltage values outputted from the sensors 2R and 2L when a user walks straight (hereinafter, referred to as a “straight-walking time”). In FIG. 3, the waveform VR1 is shown in an upper half and the waveform VL1 is shown in the lower half. During the straight-walking time, the waveform VR1 shows a first peak PR11 projecting toward a positive side from a base level, with respect to each substantially constant time interval. Note that the reference numeral “PR11” is exemplarily placed to only one peak. Here, assume that the first peak PR11 appears when the right foot of the user touches on a surface. The waveform VR1 shows a second peak PR12 between the first peaks PR11 adjacent to each other on a time axis, that projects toward a negative side from the base level, and, under the above assumption, the second peak PR12 appears when the right foot of the user leaves the surface.

Similarly, during the straight-walking time, the waveform VL1 shows a first peak PL11 and a second peak PL12 respectively projecting toward the positive and negative sides from the base level with respect to each substantially constant time interval, as shown in FIG. 3.

In the above waveforms VR1 and VL1, the first peaks PR11 and PL11 each indicates one step of the user. Accordingly, the total number of the first peaks PR11 and PL11 in a given time period indicates the number of steps of the user in the given time period. Also, by dividing a distance for which the user moved in the given time period by the number of steps, it is possible to approximately calculate a distance of a stride of the user.

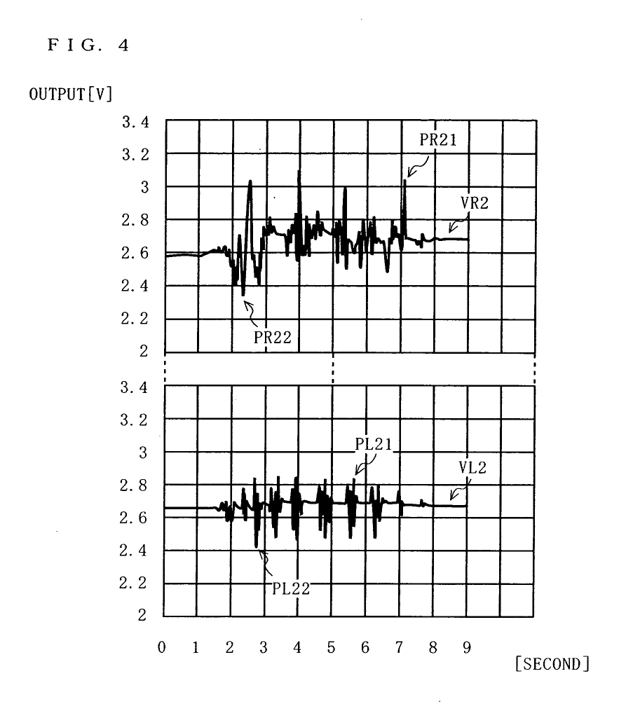

FIG. 4 is a diagram exemplarily showing temporal waveforms VR2 and VL2 for voltage values outputted from the sensors 2R and 2L when a user runs straight (hereinafter, referred to as a “straight-running time”). FIG. 4 shows the waveform VR2 in the upper half and the waveform VL2 in the lower half. Similar to the straight-walking time, during the straight-running time, the waveform VR2 respectively shows a first peak PR21 and a second peak PR22 on the positive and negative sides from the base level, with respect to each substantially constant time interval. The waveform VL2 shows first peaks PL21 and second peaks PL22 in a similar manner. However, because the user is running, a larger pressure is applied to each of the sensors 2R and 2L, and therefore, a peak PR21 is greater than a peak PR11 in value. Similarly, peaks PR22, PL21, and PL22 are respectively greater than peaks PR12, PL11, and PL12, in value. Also, in a similar manner to calculating the distance of a stride, a running pace of the user can be approximately calculated by using the above waveforms VR2 and VL2.

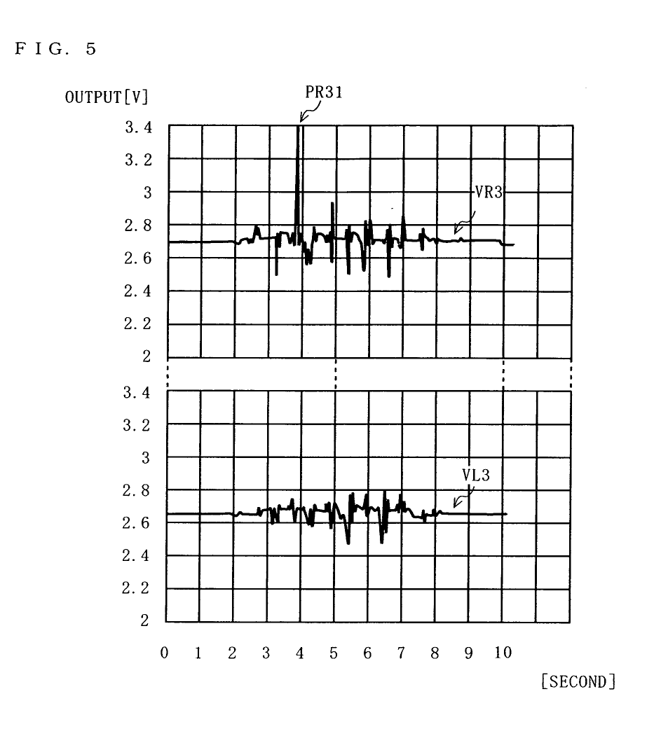

FIG. 5 is a diagram exemplarily showing temporal waveforms VR3 (upper half) and VL3 (lower half) for voltage values outputted from the sensors 2R and 2L when a user makes a right turn of ninety degrees during walking (hereinafter, simply referred to as a “right turn”). For this user, a large pressure is applied to the right-side sole, namely, to the sensor 2R, when changing the direction, and therefore, the waveform VR3 shows a peak PR31 greater than the others. Peaks occurring before or after the peak PR31 timewise appear in substantially the same size and with respect to each substantially constant time interval. Note that, when the user makes a left turn of ninety degrees during walking, temporal waveforms characteristic to the user are obtained from voltages outputted from both of the sensors 2R and 2L.

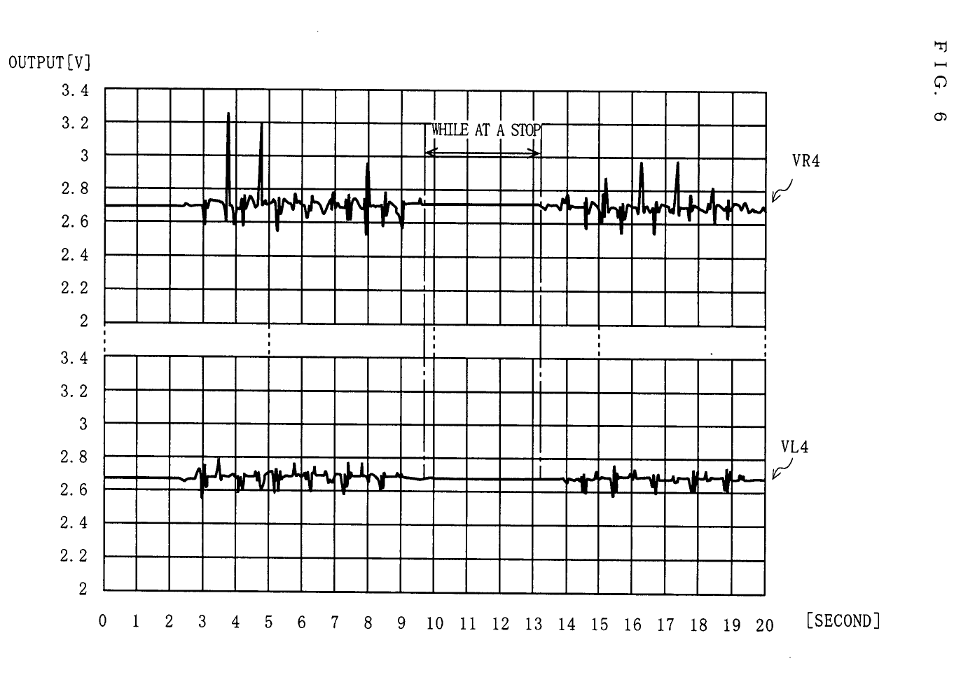

FIG. 6 is a diagram showing waveforms VR4 (upper half) and VL4 (lower half) for voltages outputted from the sensors 2R and 2L when a pedestrian temporarily stops during walking. In FIG. 6, while the pedestrian is at a stop, both the waveforms VR4 and VL4 are substantially on a certain value at around the base level.

As clearly shown in FIGS. 3 to 6, temporal waveforms for voltages outputted from both of the sensors 2R and 2L have shapes characteristic to each user.

The information acquisition/storage section 3 periodically receives and stores a current position derived in the receiver 1 while the receiver 1 can track the GPS satellite. If the receiver 1 can output a current time, the information acquisition/storage section 3 receives and stores the current time together with the current position. If the receiver 1 cannot output a current time, the information acquisition/storage section 3 acquires a current time from a timer not shown and stores the current time together with the current position obtained from the receiver 1.

Further, with respect to each predetermined time interval, the information acquisition/storage section 3 derives and stores a travel speed and a travel direction (orientation) for a user by using a position and a time previously stored and a position and a time currently stored.

Further, the information acquisition/storage section 3 periodically receives values outputted from both of the sensors 2R and 2L with a predetermined timing, regardless whether or not the receiver 1 can track a GPS satellite. Then, the information acquisition/storage section 3 stores the values outputted from both of the sensors 2R and 2L and the substantially simultaneously obtained travel speed and travel direction (orientation).

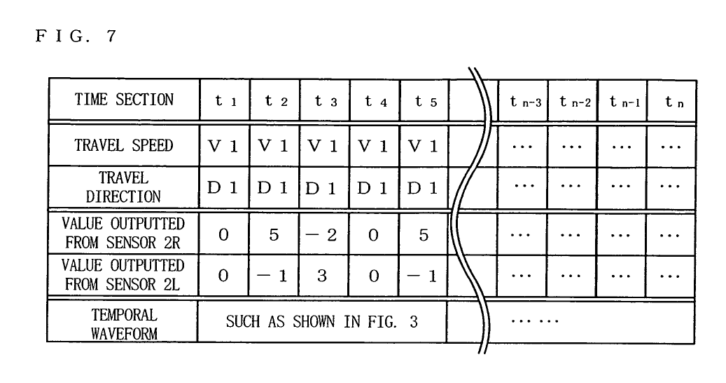

FIG. 7 is a schematic diagram showing information to be stored in the information acquisition/storage section 3. In FIG. 7, the information acquisition/storage section 3 stores a pair of the travel speed and the travel direction of the user, that is obtained using radio navigation and the values outputted from both of the sensors 2R and 2L, in chronological order. Accordingly, the information acquisition/storage section 3 stores temporal waveforms (see FIGS. 3 to 6, for example) for the values outputted from the sensors 2R and 2L. Also, a manner of walking or running is different for (characteristic to) each user. Therefore, a travel speed and a travel direction for a user correlate with temporal waveforms for values outputted from the sensors 2R and 2L. For example, currently assume that, in a first time period, a user walks straight in a place where the receiver 1 can track a GPS satellite. In the first time period, the information acquisition/storage section 3 stores a substantially constant low speed V1 (about 4 km/h) as a travel speed of the user and a substantially constant value D1 as a travel direction of the user. Also, in the first time period, the waveforms VR1 and VL1 shown in FIG. 3 are stored in the information acquisition/storage section 3.

However, even in a second time period during which the receiver 1 cannot track a GPS satellite, the locator 4 can periodically obtain values outputted from both of the sensors 2R and 2L as described above. The locator 4 correlates between the output values having predetermined values which are recently obtained from both of the sensors 2R and 2L and the output values which are previously obtained from both of the sensors 2R and 2L and are stored in the information acquisition/storage section 3, whereby it becomes possible to estimate a travel speed and a travel direction of the user. For example, if, in the second time period, the locator 4 obtains from both of the sensors 2R and 2L output values for waveforms correlating with (similar to) the waveforms VR1 and VL1 shown in FIG. 3, it is possible for the locator 4 to estimate that the user is currently traveling with a speed V1 and in a direction D1. Through integrating thus estimated travel speed and travel direction with respect to each given time, the position estimation apparatus can estimate a current position of the user.

In order to precisely measure a position, when the receiver 1 can track a GPS satellite, the locator 4 identifies a current position of the user by using an output from the receiver 1 (so-called “radio navigation”). In such a case, the locator 4 may correct the identified current position using well-known art. Here, the well-known art are: map matching; using an output from an autonomous navigation sensor; and using radio waves from a DGPS (Differential-GPS).

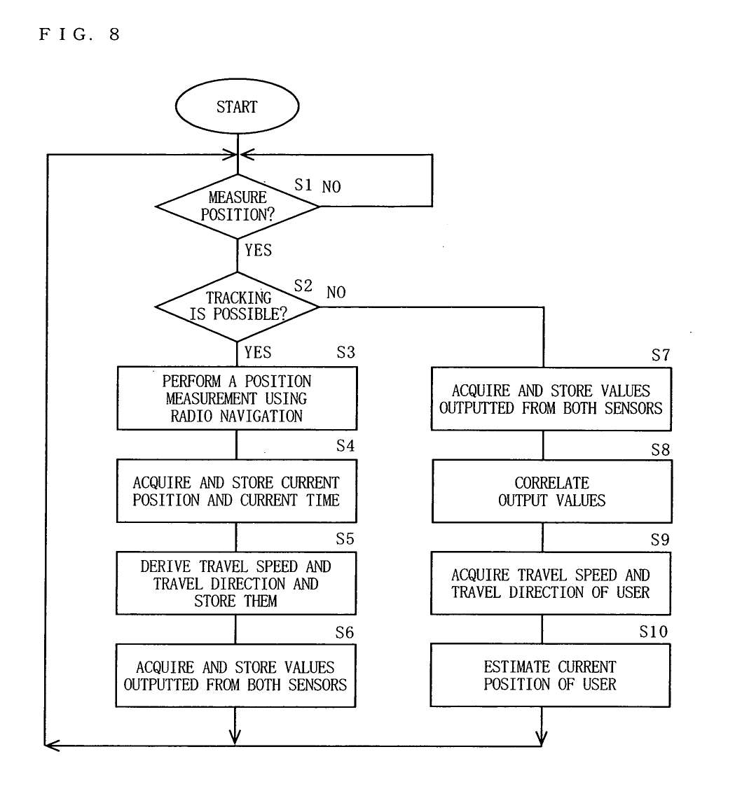

Next, with reference to the flowchart of FIG. 8, operations of the position estimation apparatus having the above configuration are described. Firstly, the locator 4 determines whether or not it is a time for measuring a current position of the user (step S1). If, for example, it is previously determined that a current position of the user is to be identified for each t second(s), it is determined whether or not t second(s) has passed since the previous measurement. Here, “t” is an arbitrary number.

If it is determined as “NO” in step S1, the locator 4 repeats step S1 so as to await the passage of t second(s) Conversely, if it is determined as “YES” in step S1, the locator 4 determines whether or not the receiver 1 can track a GPS satellite (step S2).

If it is determined as “YES”, the locator 4 performs a position measurement using the aforementioned radio navigation (step S3).

Also, the information acquisition/storage section 3 receives and stores the current position outputted from the receiver 1 for a position estimation described later (step S4) Note that, if, in step 3, the receiver 1 can output a current time, the information acquisition/storage section 3 receives and stores the current time together with the current position. If the receiver 1 cannot output a current time, the information acquisition/storage section 3 acquires the current time from a timer not shown, and stores the current time together with the current position obtained from the receiver 1.

Further, by using a position and a time previously stored and the current position and the current time currently obtained, the information acquisition/storage section 3 derives a travel speed and a travel direction (orientation) of the user and stores them (step S5).

Further, in order to estimate a position in the future, the information acquisition/storage section 3 acquires values outputted from both of the sensors 2R and 2L, and stores, together with the travel speed and the travel direction (orientation) obtained in step S5, the values outputted from both of the sensors 2R and 2L (step S6). Subsequent to the above step S6, step S1 is performed again. With the aforementioned steps S1 to S6, information (see FIG. 7) necessary for a position estimation, which will be described later, is stored in the information acquisition/storage section 3 in chronological order.

If it is determined as “NO” in step S2, the locator 4 acquires and stores values outputted from both of the sensors 2R and 2L (step S7).

Thereafter, the locator 4 selects, from among information stored in the information acquisition/storage section 3, output values having predetermined values which are recently obtained from both of the sensors 2R and 2L, namely, waveforms having shapes similar to temporal waveforms for the output values having predetermined values obtained in step S7. In other words, the locator 4 correlates between the recent output values and the previous output values (step S8).

Thereafter, the locator 4 acquires from the information acquisition/storage section 3 the travel speed and the travel direction of the user, that are stored in combination with the previous output values which form temporal waveforms similar to those for the recent output values (step S9).

Thereafter, the locator 4 integrates the travel speed and the travel direction so as to estimate a current position of the user (step S10). Note that a position estimated as such is relative to a position where it becomes impossible for the receiver 1 to track a GPS satellite. Subsequent to the above step S10, step S1 is performed again.

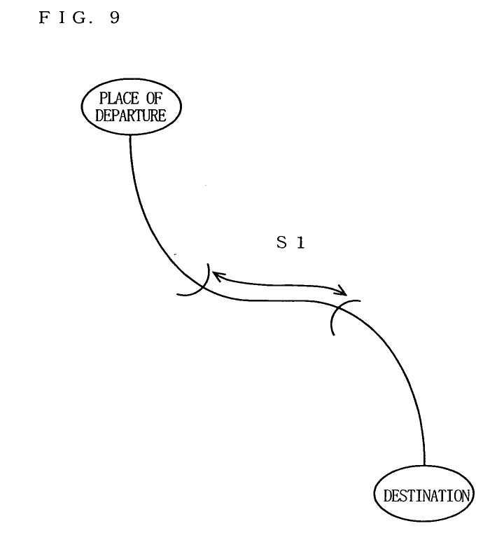

With the above-described processes, there may be a case where the user must pass, in between a place of departure and a destination, through a section S1 in which the receiver 1 cannot track an artificial satellite, as shown in FIG. 9, for example. In such a section S1, the position estimation apparatus cannot identify a position of the user by using radio navigation. Therefore, a current position of the user in the section S1 is estimated by using information stored in the information acquisition/storage section 3 and values outputted from the sensors 2R and 2L. Here, the estimated current position is a position derived last using radio navigation (namely, a position immediately before the user enters into the section S1).

As described above, the position estimation apparatus according to the present embodiment collects values outputted from the sensors 2R and 2L during a time period in which a GPS satellite can be tracked, and stores the values, outputted from the sensors 2R and 2L, correlating with a travel speed and a travel direction for a user. Even when it becomes impossible to track a GPS satellite, the position estimation apparatus collects values outputted from the sensors 2R and 2L. Thereafter, the position estimation apparatus searches the information acquisition/storage section 3 for previous output values correlating with temporal waveforms formed with the recent output values. Then, the position estimation apparatus integrates the travel speed and the travel direction which are in combination with the searched output values that are obtained from the sensors 2R and 2L and previously stored, so as to estimate a current position of the user. As clearly described in the above, according to the present position estimation apparatus, a current position of a user can be autonomously estimated without depending on radio waves from a GPS satellite.

Note that a position in the height direction can be estimated by including an acceleration sensor in the position estimation apparatus. Also, in a case where a highly precise map is retained, it is possible that the position estimation apparatus performs well-known map matching so as to enhance precision of a current position of a user autonomously estimated.

Also, it is preferable that, since a large number of pieces of information are stored in the information acquisition/storage section 3 in chronological order, those pieces of information be periodically subjected to a statistical process and a representative temporal waveform for an output value from each of the sensors 2R and 2L be thereby generated with respect to each state of travel of the user.

Also, since the number of steps or the running pace can be detected by using a temporal waveform for a value outputted from each of the sensors 2R and 2L, a position may be estimated based thereon.

While the invention has been described in detail, the foregoing description is in all aspects illustrative and not restrictive. It is understood that numerous other modifications and variations can be devised without departing from the scope of the invention.

### INDUSTRIAL APPLICABILITY

A position estimation apparatus according to the present invention can be mounted to a navigation apparatus, a mobile telephone, a personal computer, or the like operable to navigate a pedestrian.

1. A position estimation apparatus comprising:
a receiver for receiving information sent from an artificial satellite and deriving a current position based on the received information;
a right-side pressure sensor for detecting a pressure applied from a right foot of a user to a ground;
a left-side pressure sensor for detecting a pressure applied from a left foot of the user to the ground; and
an information acquisition/storage section for acquiring a piece of predetermined information when the receiver is able to track the artificial satellite, wherein
the information acquisition/storage section
acquires the current position obtained from the receiver and an output value from each of the pressure sensors,
derives a travel speed and a travel direction of the user based on the current position obtained from the receiver, and then stores at least the derived travel speed and travel direction and the obtained output value,
the position estimation apparatus
further comprises a locator for acquiring the output value from each of the sensors when the receiver is unable to track the artificial satellite, and
the locator
retrieves the travel speed and the travel direction of the user from the information acquisition/storage section, based on the output value acquired from each of the sensors and the output value stored in the information acquisition/storage section, and
estimates a current position of the user based on the retrieved travel speed and travel direction.

2. The position estimation apparatus according to claim 1, wherein the locator
selects, from among output values stored in the information acquisition/storage section, an output value correlating with that acquired from each of the sensors, and
retrieves the selected output value and the travel speed and travel direction stored in the information acquisition/storage section.

3. The position estimation apparatus according to claim 2, wherein the locator selects, from among temporal waveforms for the output values stored in the information acquisition/storage section, a temporal waveform correlating with that for the output value acquired from each of the sensors.

4. The position estimation apparatus according to claim 1, wherein the locator respectively integrates the retrieved travel speed and travel direction so as to estimate the current position of the user.

5. The position estimation apparatus according to claim 1, wherein the sensors are respectively provided to outsoles of a pair of shoes.

6. The position estimation apparatus according to claim 1, wherein each of the sensors includes a piezo element.

7. A position estimation method comprising:
a position measurement step of receiving information sent from an artificial satellite and deriving a current position based on the received information;
a detection step of detecting a pressure applied from a foot of a user to a ground;
a first acquisition step of acquiring the current position obtained in the position measurement step and a value of the pressure detected in the detection step when tracking the artificial satellite is possible;
a storage step of deriving a travel speed and a travel direction of the user based on the current position obtained in the position measurement step, and then storing at least the derived travel speed and travel direction and the value of the pressure obtained in the first acquisition step;
a second acquisition step of acquiring the value of the pressure obtained in the detection step when tracking the artificial satellite is impossible;
a third acquisition step of retrieving the travel speed and travel direction, of the user, stored in the storage step, based on the value of the pressure acquired in the second acquisition step and the value of the pressure stored in the storage step; and
a position estimation step of estimating a current position of the user based on the travel speed and travel direction obtained in the third acquisition step.
